(19) United States
(12) Patent Application Publication
(10) Pub. No.: US 2026/0263948 A1
(43) Pub. Date: Sep. 10, 2026

(54) USING ML MODELS TO MATCH PLAYERS TOGETHER FOR GAME PLAY

(71) Applicant: Sony Interactive Entertainment Inc., Tokyo (JP)

(72) Inventors: Abigail Edwards, San Francisco, CA (US); Snigdha Sah, San Francisco, CA (US); Syrsha Harvey, San Francisco, CA (US)

(73) Assignee: Sony Interactive Entertainment Inc., Tokyo (JP)

(21) Appl. No.: 19/071,594

(22) Filed: Mar. 5, 2025

(51) Int. Cl. A63F 13/795

(52) U.S. Cl. CPC A63F 13/795

(57) ABSTRACT

Systems and methods of the present disclosure include tracking, by a system including at least one processor and a memory, user interactions of a first user in a game environment, gathering, by the system, implicit user gameplay information from the user interactions of the first user in the game environment, receiving, by the system, explicit user gameplay information from the first user, executing, by the system, the adaptive player matching application including a machine learning algorithm, analyzing the implicit user gameplay information, via the adaptive player matching application, to determine predicted user preferences for the first user, determining, by the adaptive player matching application, predicted user preferences for the first user, and based at least in part on the predicted user preferences and the explicit user gameplay information, generating, via the adaptive player matching application, recommended player matches with one or more other users in the game environment.

### BACKGROUND

The video game industry has expanded significantly such that users have virtually infinite options for video games and other media types for interaction. Example gaming platforms may be the Sony PlayStation®, Sony PlayStation2® (PS2), Sony PlayStation3® (PS3), Sony PlayStation3® (PS4), Sony PlayStation3® (PS5), etc., each of which is sold in the form of a game console. As is well known, the game console is designed to connect to a monitor (usually a television) and enable user interaction through handheld controllers. The game console is designed with specialized processing hardware, including a CPU, a graphics synthesizer for processing intensive graphics operations, a vector unit for performing geometry transformations, and other glue hardware, firmware, and software. Online gaming is also possible, where a user can interactively play against or with other users over the Internet. Other gaming platforms may include PlayStation® Portal and PlayStation® VR2. Today's game console is not used just to play games, but are used as a computing device that can access the Internet to search for content, browse for multimedia downloads, shop online music, videos or movies, participate in multiplayer games, enter virtual worlds, etc. Thus, a community of users is accessing online media, and this community of users has powerful computing devices and versatile interfaces.

Players may have preferences for other players that they would like to play with. For example, a specific person might prefer to play with someone who prefers to talk via a game console microphone and another person would prefer to play with someone who prefers to play with someone who prefers to use a chat application. These players may not be a good match.

Embodiments address these and other problems, individually or collectively.

### SUMMARY

Embodiments of the present invention provide methods, systems, and computer programs for executing an adaptive player matching application for interacting in a game environment.

According to one embodiment, a method for executing an adaptive player matching application for interacting in a game environment includes tracking, by a system including at least one processor and a memory, user interactions of a first user in the game environment, gathering, by the system, implicit user gameplay information from the user interactions of the first user in the game environment, receiving, by the system, explicit user gameplay information from the first user, executing, by the system, the adaptive player matching application including a machine learning algorithm, analyzing the implicit user gameplay information, via the adaptive player matching application, to determine predicted user preferences for the first user, determining, by the adaptive player matching application, predicted user preferences for the first user, and based at least in part on the predicted user preferences and the explicit user gameplay information, generating, via the adaptive player matching application, recommended player matches with one or more other users in the game environment.

The method may include various optional embodiments. The method may further include training the machine learning algorithm on user interactions of at least a second user in the game environment. Receiving the explicit user gameplay information may include requesting the first user to provide game preferences prior to engaging with a game or during profile creation. The implicit user gameplay information may be gathered from one or more inputs where the one or more inputs includes time data information associated with one or more titles in the game environment, player skill levels, shopping cart information, social media information, and user search history information. The method may further include determining, by the system using the machine learning algorithm, a user skill of the first user based on the analyzed implicit user gameplay information, determining, by the system using the machine learning algorithm, a complimentary skill to the user skill of the first user, and as part of the generating recommended player matches, selecting at least one of the one or more other users in the game environment with the complimentary skill. The user skill may include a first tool available to the first user in the game environment and the complimentary skill may include a second tool available to the one or more other users in the game environment. The method may further include requesting user feedback at at least a predetermined time intervals in the game and in response to the user feedback, modifying the predicted user preferences.

According to another embodiment, a system includes one or more storage media storing instructions and one or more processors to execute the instructions causing the system to perform operations including tracking, by the system, user interactions of a first user in a game environment, gathering, by the system, implicit user gameplay information from the user interactions of the first user in the game environment, receiving, by the system, explicit user gameplay information from the first user, executing, by the system, an adaptive player matching application including a machine learning algorithm, analyzing the implicit user gameplay information, via the adaptive player matching application, to determine predicted user preferences for the first user, determining, by the adaptive player matching application, predicted user preferences for the first user, and based at least in part on the predicted user preferences and the explicit user gameplay information, generating, via the adaptive player matching application, recommended player matches with one or more other users in the game environment.

The system may include various optional embodiments. The operations may further include training the machine learning algorithm on user interactions of at least a second user in the game environment. Receiving the explicit user gameplay information may include requesting the first user to provide game preferences prior to engaging with a game or during profile creation. The implicit user gameplay information may be gathered from one or more inputs where the one or more inputs include time data information associated with one or more titles in the game environment, player skill levels, shopping cart information, social media information, and user search history information. The operations may further include determining, by the system using the machine learning algorithm, a user skill of the first user based on the analyzed implicit user gameplay information, determining, by the system using the machine learning algorithm, a complimentary skill to the user skill of the first user, and, as part of the generating recommended player matches, selecting at least one of the one or more other users in the game environment with the complimentary skill. The user skill may include a first tool available to the first user in the game environment and the complimentary skill may include a second tool available to the one or more other users in the game environment. The operations may further include requesting user feedback at at least a predetermined time intervals in the game and in response to the user feedback, modifying the predicted user preferences.

According to another embodiments, one or more non-transitory computer-readable storage media store instructions that, upon execution by one or more processors of a system, cause the system to track, by the system, user interactions of a first user in a game environment, gather, by the system, implicit user gameplay information from the user interactions of the first user in the game environment, receive, by the system, explicit user gameplay information from the first user, execute, by the system, an adaptive player matching application including a machine learning algorithm, analyze the implicit user gameplay information, via the adaptive player matching application, to determine predicted user preferences for the first user, determine by the adaptive player matching application, predicted user preferences for the first user, and based at least in part on the predicted user preferences and the explicit user gameplay information, generate, via the adaptive player matching application, recommended player matches with one or more other users in the game environment.

The computer-readable storage media may include various optional embodiments. The system may train the machine learning algorithm on user interactions of at least a second user in the game environment. Receiving the explicit user gameplay information may include requesting the first user to provide game preferences prior to engaging with a game or during profile creation. The implicit user gameplay information is gathered from one or more inputs where the one or more inputs includes time data information associated with one or more titles in the game environment, player skill levels, shopping cart information, social media information, and user search history information. The system may determine a user skill of the first user based on the analyzed implicit user gameplay information, determine a complimentary skill to the user skill of the first user, and, as part of the generating recommended player matches, selecting at least one of the one or more other users in the game environment with the complimentary skill. The user skill may include a first tool available to the first user in the game environment and the complimentary skill may include a second tool available to the one or more other users in the game environment.

### BRIEF DESCRIPTION OF THE DRAWINGS

Features, embodiments, and advantages of the present disclosure are better understood when the following Detailed Description is read with reference to the accompanying drawings.

FIG. 1 illustrates a computer system, according to embodiments of the present disclosure.

FIG. 2 illustrates an example of a game environment, according to some embodiments of the present disclosure.

FIG. 3 illustrates an adaptive player matching application for interacting in a game environment, according to embodiments of the present disclosure.

FIG. 4 is a flowchart of a method for executing an adaptive player matching application for interacting in a game environment, according to embodiments of the present disclosure.

FIG. 5 illustrates an example of a hardware system suitable for implementing a computer system, according to embodiments of the present disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Embodiments of the present disclosure provide methods and systems to for using machine learning (ML) models in an adaptive player matching application. Embodiments of the present disclosure leverage data from user profiles in a game environment and machine learning capabilities to match players across the globe. Embodiments of the present disclosure gather implicit and explicit information about user preferences to make player matches and adapt player matches as user preferences change. A gaming system and game environment for implementing embodiments of the present disclosure are further described herein.

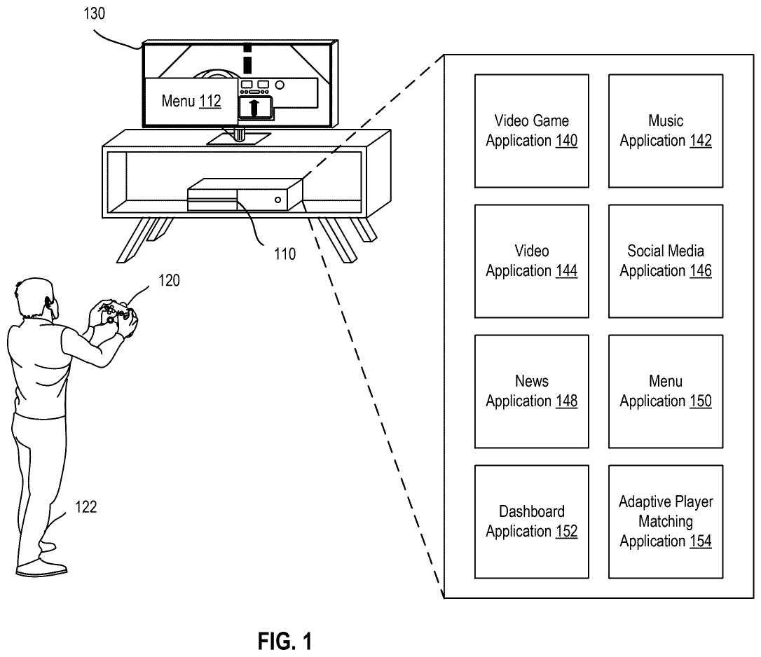

FIG. 1 illustrates a computer system, according to an embodiment of the present disclosure. As illustrated, the computer system 100 includes a video game console 110, a video game controller 120, and a display 130. Although not shown, the computer system may also include a backend system, such as a set of cloud servers, that is communicatively coupled with the video game console 110. The video game console 110 is communicatively coupled with the video game controller 120 (e.g., over a wireless network) and with the display 130 (e.g., over a communications bus). A user 122 operates the video game controller 120 to interact with the video game console 110. These interactions may include playing a video game presented on the display 130, interacting with a menu 112 presented on the display 130, and interacting with other applications of the video game console 110 (e.g., with media applications to stream media from an online content source or to play a media file from the local storage of the video game console 110).

The video game console 110 includes a processor and a memory (e.g., a non-transitory computer-readable storage medium) storing computer-readable instructions that can be executed by the processor and that, upon execution by the processor, cause the video game console 110 to perform operations related to various applications. In particular, the computer-readable instructions can correspond to program codes for the various applications of the video game console 110 including video game application 140, music application 142, video application 144, social media application 146, and news application 148. A video game application, such as video game application 140, generally represents a computer application executable to present video game content, receive user interaction with the video game content, and accordingly update the video game content. A media application, such as music application 142, video application 144, social media application 146, and news application 148, generally represents a computer application executable to present media content including audio, video, and/or other media types, receive user interaction with the media content, and accordingly update the media content. The media content can be streamed from a remote content source or can be presented form local storage of the video game console 110. Further, other applications can be likewise included in the video game console 110, such as a chat application. The availability of a video game application, media application, and/or other type of computer application to the user 122 via the video game console 110 can depend on a user identifier of the user 122 (e.g., upon a login to the video game console 110, the availability of the computer applications can depend on the user identifier used in the login). In addition, the video game console 110 includes a menu application 150, a dashboard application 152, and an adaptive player matching application 154. The menu application 150 can present a home user interface (UI) in a GUI of the display 130. The dashboard application 152 can present an arrangement of interactive UI widgets in a dashboard page on the GUI.

The video game controller 120 is an example of an input device. The video game controller 120 may allow the user 122 to interact with one or more GUIs presented by the video game consol 110 on the display 130. For example, using one or more directional control inputs (e.g., a joystick and/or a directional pad) the user can navigate to and within various menus, dashboards, and UI elements. Other types of the input device are possible including, a keyboard, a touchscreen, a touchpad, a mouse, an optical system, a microphone, a camera, or other user devices suitable for receiving input of a user. For example, a microphone may allow the user 122 to interact with the GUIs using various voice commands. As another example, a camera may allow the user 122 to interact with the GUIs using various gesture commands.

Upon an execution of the video game application 140 by the video game console 110, a rendering process of the video game console 110 presents video game content (e.g., illustrated as a car race video game content) on the display 130. Upon user input from the video game controller 120 (e.g., a user push of a particular key or button), the rendering process also presents the menu 112. Additionally, or alternatively, the menu 112 may be presented as an initial landing page in response to a user powering-on the video game console 110 and/or waking the video game consol 110 from a suspended state. Depending on the user input, the menu 112 corresponds to the home UI page, a landing page, or the like. The menu 112 can be presented in a layer over the video game content.

Upon the presentation of the menu 112, the user control changes from the video game application 140 to the menu application 150. Upon receiving a user input from the video game controller 120 requesting interactions with the menu 112, an underlying application (e.g., the menu application 150, the dashboard application 152, or the adaptive player matching application 154 as applicable) supports such interactions by updating the menu 112 and launching any relevant application in the background or foreground. The user 122 can exit the menu 112 or automatically dismiss the menu 112 upon the launching of an application in the background or foreground. Upon exiting the menu 112 or the dismissal based on a background application launch, the user control changes from the underlying application to the video game application 140.

As described in more detail below, the dashboard application 152, when executed, may generate a dashboard (e.g., a “widget menu,” “landing page,” and/or “explore page”) configured to present information from applications and services available to the video game console 110 as interactive UI widgets. The term “widget” is used herein as an example of an interactive UI element generated and/or presented by the dashboard application 152 and corresponding to an application or service of the computer system. Other implementations to present a UI element are possible, including any type of icon, whether a widget, a tile, a thumbnail, a text description, a multiple column element with textual or graphical description in each column, and the like. As described further, below, widgets may be presented with application information and/or dynamic content presented with the widget in a media library. For example, the dashboard application 152 may generate and/or present widgets associated with media applications, system applications and/or services, video game applications, or the like.

As described in more detail below, the dashboard application 152 may be executed via multiple avenues of ingress. For example, the dashboard application 152 may be executed by a pre-defined user interaction (e.g., via controller 120, a voice command from the user 122, activating and/or powering-on the video game consol 110 etc.) and/or by navigating one or more menus and/or sub-menus of the video game console 110 (e.g., menu 112).

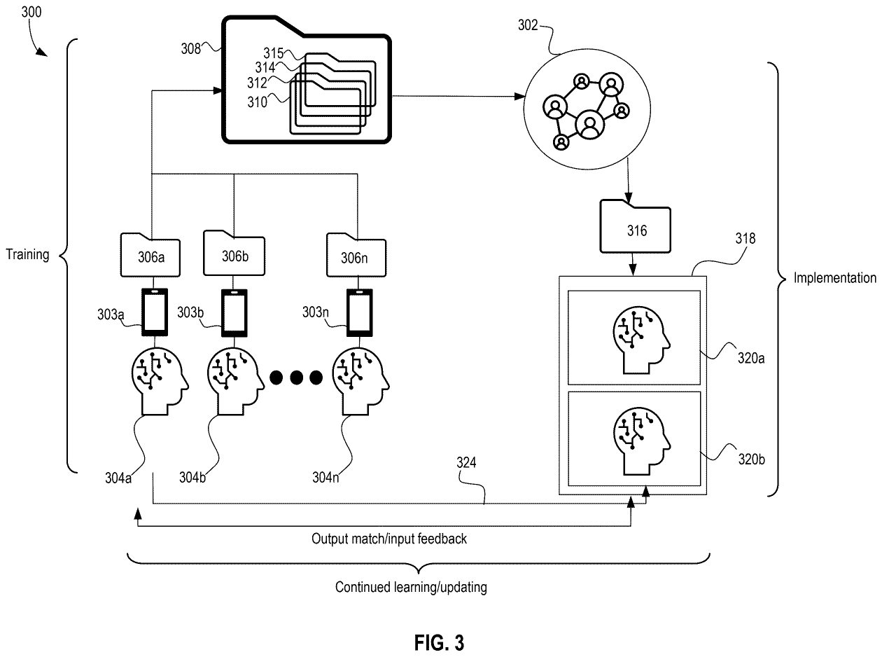

According to various embodiments, and as described in further detail below, the adaptive player matching application 154 may be executed in a game (e.g., in a game environment) for matching players based on explicit and implicit user gameplay information, to be discussed in further detail below. According to various embodiments, the adaptive player matching application 154 is a local instance of the application and processing of inputs to the application occurs in a cloud-based environment, such as game environment 300 as described with respect to FIG. 3. In other embodiments, processing for the adaptive player matching application 154 may be performed locally and/or via the cloud-based environment.

Although FIG. 1 illustrates that the different applications are executed on the video game console 110, the embodiments of the present disclosure are not limited as such. Instead, the applications can be executed on the backend system (e.g., the cloud servers) and/or their execution can be distributed between the video game console 110 and the backend system.

Embodiments of the present disclosure leverage data from user profiles in a game environment and machine learning capabilities to match players across the globe. Players may have preferences for other players that they would like to play with. For example, a specific person might prefer to play with someone who prefers to talk via a game console microphone and another person would prefer to play with someone who prefers to play with someone who prefers to use a chat application. These players may not be a good match. Embodiments of the present disclosure gather implicit and explicit information about user preferences to make player matches and adapt player matches as user preferences change.

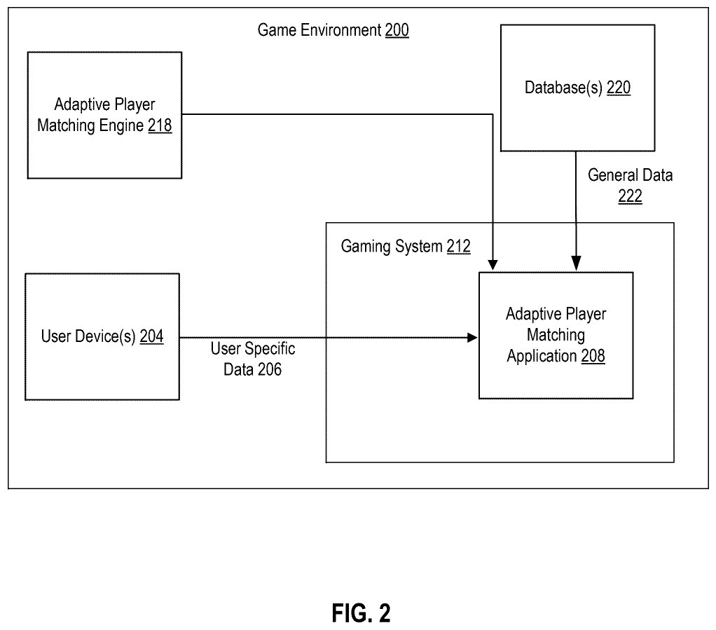

FIG. 2 illustrates an example of a game environment 200, according to some embodiments of the present disclosure. The game environment 200 may include at least a user device(s) 204, a gaming system 212, a database(s) 220, and an adaptive player matching engine 218. The gaming system 212 can receive user specific data 206 from the user device 204. The gaming system 212 may also receive general data 222 from a database 220, to be described in further detail below. The adaptive player matching engine 218 of the gaming system 212 recommended player matches according to embodiments of the present disclosure. The adaptive player matching engine 218 may be executed on a cloud-based server or the like. Each user device 204 runs a local instance of an adaptive player matching application 208, such as the adaptive player matching application 154 as described with respect to FIG. 1.

According to various embodiments, a database 220 can include general data 222 that supports system operations, game mechanism, and user engagement. For example, the database 220 can include game environment data, such as in-game world states, weather conditions, and dynamically changing elements like non-playable character (NPC) behavior or item spawn locations. The database 220 can include general user engagement metrics, such as average time spent on different game modes, popular levels or maps, and frequency of activity across various game features. The general user engagement metrics can be used to identify patterns in user behavior, such as which modes are most engaging or which areas of the game require balancing or improvement. The database 220 can also include game performance metrics, such as frame rates, load times, crash log, and latency statistics, which are critical for optimizing the technical aspects of the game and ensuring smooth gameplay. The database 220 can include inventory data, such as available in-game items, skins, or vehicles, as well as data on how frequently these items are used or unlocked by players. The database 220 can include event participation data, such as the number of players joining seasonal or time-limited events, their completion rates, and the outcomes of these events. The database 220 can also include leaderboard ranking and information for competitive or cooperative play, such as player skill ratings, connection quality, and regional-based preferences.

The database 220 can include user-specific data such as personal information, account details, subscription tiers, playtime statistics, friend lists, purchase history, and feedback provided by the user. The database 220 can also include user profile data such as gaming preferences like favorite genre, difficulty levels, unlocked achievements, skill level, in-game behavior, and avatar customization. The database 220 can further include comprehensive data such as game-specific data, content data, usage metrics, content recommendation data, community and social data, system data, and cross-platform data.

The database 220 can be embedded directly within the gaming console or system and stored on a local hard drive or solid-state drive. The gaming system 212 can communicate with the database 220 using an application programing interface (API) or file system integrations. Additionally, the one or more databases 220 can be hosted externally, such as on cloud servers. Cloud databased can communicate with the gaming system via internet protocols, such as RESTful APIs or WebSocket connections, providing real-time updates and synchronization. Additionally, hybrid setups are possible, where certain data (e.g., critical game files) is stored locally, while dynamic data (e.g., live game stats) resides in the cloud. The database 220 can also be integrated into third party services, such as gaming networks (e.g., PlayStation Network or Xbox Live). These external databases communicate with the gaming system through secure authentication protocols and encrypted data streams to ensure privacy and integrity. Furthermore, certain gaming systems may utilize edge computing, where smaller, distributed databases are located closer to the end user to reduce latency for high-performance scenarios like competitive gaming. The gaming system 212 can interact with the databases 220 through middleware or game engines which provide structured pathways for database queries and responses.

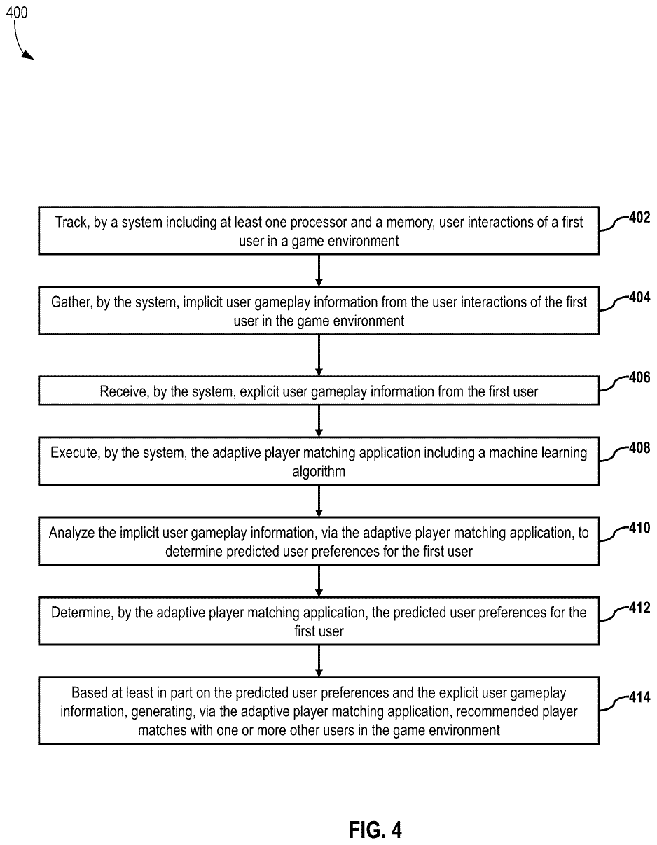

According to various embodiments, the adaptive player matching engine 218 generates recommended player matches using various operations as described with respect to FIG. 4 and process 400 in further detail below.

According to various embodiments, the ML model of the of the adaptive player matching engine 218 is trained to be capable of processing natural language descriptions. The natural language training input may be part of a plurality of inputs. The natural language input can be processed by the ML model for generating outputs such recommended player matches. To guide the training process, the natural language input may include ground truth information. The ground truth information may be further validated against the outputs generated by the ML model, according to various embodiments, for finding discrepancies and refining the ML model. The ML model may be iteratively refined via a feedback loop and additional training cycles.

According to various embodiments of the present disclosure, the ML model of the adaptive player matching engine 218 may receive feedback from the user device 204 for updating and training the ML model. For example, in response to the user feedback, the ML model may modify the predicted user preferences. For example, when user gameplay diverges from typical gameplay behavior, the ML model may recognize this change in behavior and adapt to accommodate new behaviors. Furthermore, the ML model may generate inquiries to determine whether the predicted user preferences are still accurate or whether the predicted user preferences need to be updated. The ML model may be updated in response to feedback and/or in response to identifying a change in user behavior. The ML model may be updated continuously and/or at predetermined intervals or as new inputs are received for training the ML model. Once the training process achieves a satisfactory level of accuracy and consistency, the ML model may be executed as part of the adaptive player matching engine 218.

FIG. 3 illustrates an embodiment of a method for executing an adaptive player matching engine 302 for interacting in a game environment 300. The adaptive player matching engine 302 may be executed on a cloud-based server or the like. Each user 304 may be associated with a user device 303 that runs a local instance of an adaptive player matching application, such as the adaptive player matching application 154 as described with respect to FIG. 1. The adaptive player matching engine 302 uses a machine learning (ML) model to provide a user 304 with player matches based at least in part on affirmative preferences and adaptable criteria based on gameplay or the like. According to the shown embodiment, the method may include a plurality of users 304. Each user 304 is associated with a user profile 306. According to various embodiments, the user profile 306 may include user information such as game preferences (e.g., including genres such as action games, fighting games, role playing games, shooting games, sports games, etc.) and explicit user gameplay information. Explicit user gameplay information 314 may refer to user preferences for user interactions. For example, a first user 304a may input or otherwise select preferences for a player match when the first user 304a sets up their user profile 306a and/or updates their user profile 304a. Explicit user gameplay information 314 may be requested by the game environment 300 prior to the first user 304a engaging with a game in the game environment 300 or during profile creation. Explicit user gameplay information 314 may include a length of time that the user is interested in engaging with a matched user (e.g., just for the gaming session, until the game is completed, for one or more levels within the game, etc.), a matched user having a certain skill type, a matched user for a particular game, etc.

According to various embodiments, a plurality of inputs 308 are gathered within the game environment 300. The inputs 308 may include user interactions 310 in the game environment for each of the users 304. The system further gathers implicit user gameplay information 312 from the user interactions 310. For example, implicit user gameplay information 312 may include a predicted user preference or a predicted user skill. In some embodiments, the machine learning model of the adaptive player matching engine 302 is trained on user interactions 310 of at least a second user 304b in the game environment 300.

In various embodiments, the implicit user gameplay information 312 may be gathered from one or more inputs associated with each user profile 306. The user profile 306 may include one or more inputs such as time data information associated with one or more titles in the game environment, player skill levels, shopping cart information, social media information, user search history information, etc. For example, search and/or purchase history associated with a game library (e.g., game store) in the game environment may be used to determine a user's interests. A user might be interested in a new type of game and may be matched with a user who already plays this type of game. The one or more inputs from the user profile 306 may be used to predict implicit user gameplay information 312 according to various embodiments. In various embodiments, the one or more inputs may be gathered from social media applications. Other inputs 315 may include biometric information such as facial recognition technology implemented into the gaming environment such as through a user console or the like. Other inputs may include any combination of chat information, facial recognition data, time data associated with the user engaging with the game, social media information, biometric data, audio data, etc.

Implicit user gameplay information 312 may include other information such as playing hours that users 304 are playing. The adaptive player matching engine 302 may use playing hour information to match users based on hours of typical play that overlap.

In some embodiments, the adaptive player matching engine 302 generates the implicit user gameplay information 312 based on the inputs 308. For example, the ML model of the adaptive player matching engine 302 may receive information associated with the user gameplay and generate suggestions to the user based at least in part on the user gameplay. For example, if a user is playing an adventure game but struggles with spatial awareness skills (as determined by user gameplay information in the adventure game presently and/or user gameplay in other games), the adaptive player matching engine 302 may suggest a recommended player match 320 that does have spatial awareness skills.

Users 304 may have various user skills that may be used by the adaptive player matching engine 302 to generate recommended player matches 320. For example, a user skill may include offensive skills (e.g., for sports games or the like). Complimentary skills for offensive skills may include defensive skills (e.g., similarly, for sports games or the like). Pairs of skills may include, for shooter games, aiming skills and spatial skills, in some embodiments. In other embodiments, a pair of skills may include close range aiming and healing skills that complement longer range aiming skills. In yet another embodiment, a pair of skills may include a player who likes to beat bosses and a player who does not like that element of the game. Accordingly, embodiments of the present disclosure include where the adaptive player matching engine 302 determines a user skill of the first user based on the analyzed implicit user gameplay information. The adaptive player matching engine 302 may then determine a complimentary skill to the user skill of the first user and, as part of the generating recommended player matches, the adaptive player matching engine 302 may select a recommended player match 320 in the game environment 300 with the complimentary skill.

In similar embodiments, the adaptive player matching engine 302 may use the implicit user gameplay information 312 and/or the explicit user gameplay information 314 to determine predicted user preferences 316 to generate recommended player matches 320. Predicted user preferences 316 may include a preferred amount of communication, preferences for speed of completion of a game (e.g., users who like to speed through games may be a closer match than users who like to collect everything within the game), overlapping hours of play, preferred stop points or times within games, etc. For example, the adaptive player matching engine 302 may determine that users like to stop at similar points within the game (e.g., at checkpoints, after battles, at the beginning or end of levels, etc.). The recommended player matches 320 may be designed to match user with similar interests, or the recommended player matches 320 may match users with opposite preferences to keep the users playing longer. Other pairings may be used to form teams including two or more users for various games. In other embodiments, the adaptive player matching engine 302 may make quick connections between users who are interested in low stakes games (e.g., party games).

The explicit user gameplay information 314 is also an input 308 according to various embodiments. The adaptive player matching engine 302 receives the inputs 308 and analyzes at least the implicit user gameplay information 312 to determine predicted user preferences 316 and recommended player matches 320 for the first user 302a. In particular, the one or more machine learning operations ingest one or more inputs 308 to predict user preferences 316. For example, the adaptive player matching engine 302 predicts the user preferences 316 for the first user 304a. The adaptive player matching engine 302, based at least in part on the predicted user preferences 316 for the first user 304a and the explicit user gameplay information 314 extracted from the user profile 306a associated with the first user 304a, generates a menu 318 of recommended player matches 320 to output to the first user 304a.

According to some embodiments, the adaptive player matching engine 302 may generate a percentage of matching that is shown with each of the recommended player matchers 320. For example, a recommended player match 320 may have a percentage compatibility with the first user 320a. A percentage compatibility may be computed based on the inputs and similarities between a first user's preferences and a second user's preferences. The recommended player matches 320 may be output in ascending and/or descending order of percentage compatibility. In some embodiments, the recommend player match 320 accepts a request 324 to play prior to engaging in a game with the first user 320a.

According to some embodiments, different inputs may be weighted differently, and the weights may be predetermined by the user and/or the game developer. For example, explicit user preferences of the explicit user gameplay information 314 may be weighed more heavily than predicted user preferences 316. In some embodiments, a predetermined threshold may be set by the user and/or by the game developer for the recommend player matches 320 to be output to the user. For example, a user may prioritize having overlapping playing hours compared to having matching communication styles (e.g., audio vs. chat, etc.). The menu 318 may only show recommended player matches 320 that meet the predetermined threshold, for example, an 80% compatibility, an 85% compatibility, a 90% compatibility, etc. The thresholds may be adjusted manually and/or by the adaptive player matching engine 302, for example, in response to user feedback regarding the accuracy of the recommended player matches 320.

In various embodiments, the users 304 update their user profile 306 on an ongoing basis. The game environment 300 may prompt the users 304 to update their user profiles 306 at predetermined intervals (e.g., once a week, once a month, once a quarter, etc.). The user 304 may update their user profile 306 at any time.

According to various embodiments, the ML model of the of the adaptive player matching engine 302 is trained to be capable of processing natural language descriptions. The natural language training input may be part of the plurality of inputs 308. The natural language input can be processed by the ML model for generating outputs such as the user preferences 316, which can include a resource to be used to further generate the menu 318 of matches 320. To guide the training process, the natural language input may include ground truth information, which can act as a reference dataset containing predefined matching parameters such as user skills and complimentary skills. The ground truth information may be further validated against the outputs generated by the ML model, according to various embodiments, for finding discrepancies and refining the ML model. The ML model may be iteratively refined via a feedback loop and additional training cycles.

According to various embodiments of the present disclosure, the ML model of the adaptive player matching engine 302 may receive feedback from the user 304 for updating and training the ML model. For example, in response to the user feedback, the ML model may modify the predicted user preferences. For example, when user gameplay diverges from typical gameplay behavior, the ML model may recognize this change in behavior and adapt to accommodate new behaviors. Furthermore, the ML model may generate inquiries to determine whether the predicted user preferences are still accurate or whether the predicted user preferences need to be updated. The ML model may be updated in response to feedback and/or in response to identifying a change in user behavior. The ML model may be updated continuously and/or at predetermined intervals or as new inputs are received for training the ML model. Once the training process achieves a satisfactory level of accuracy and consistency, the ML model may be executed as part of the adaptive player matching engine 302.

FIG. 4 is a flowchart of a method for executing an adaptive player matching application for interacting in a game environment. Block 402 includes tracking, by a system including at least one processor and a memory, user interactions of a first user in the game environment. The platform may be a gaming platform that hosts a plurality of games titles and a plurality of users such that users can play with each other or by themselves. User interactions may include video communication, audio communication, text communication, engaging with the same game and interactions within the game, etc., or any combination thereof.

Block 404 includes gathering, by the system, implicit user gameplay information from the user interactions of the first user in the game environment. Implicit user gameplay information may include a predicted user preference or a predicted user skill. Implicit user gameplay information may be gathered from one or more inputs associated with a user profile of the first user. Furthermore, the implicit user gameplay information may be gathered from one or more inputs, wherein the one or more inputs includes time data information associated with one or more titles in the game environment, player skill levels, shopping cart information, social media information, user search history information, etc., or any combination thereof. A user profile may include one or more inputs such as time data information associated with one or more titles in the game environment, player skill levels, shopping cart information, social media information, user search history information, etc. The one or more inputs from the user profile may be used to predict implicit user gameplay information according to various embodiments. In various embodiments, the one or more inputs may be gathered from social media applications. Other inputs may include biometric information such as facial recognition technology implemented into the gaming environment such as through a user console or the like. Other inputs may include any combination of chat information, facial recognition data, time data associated with the user engaging with the game, social media information, biometric data, audio data, etc. In some embodiments, one or more of the machine learning models of the adaptive player matching application are trained on user interactions of at least a second user in the game environment.

Block 406 includes receiving, by the system, explicit user gameplay information from the first user. Explicit user gameplay information may refer to user preferences for user interactions. For example, a first user may input or otherwise select preferences for a player match when the first user sets up their user profile and/or updates their user profile. Explicit user gameplay information may be requested by the platform prior to the first user engaging with a game in the game environment or during profile creation. According to some embodiments, receiving the explicit user gameplay information includes requesting the first user to provide game preferences prior to engaging with a game or during profile creation.

Block 408 includes executing, by the system, the adaptive player matching application including a machine learning algorithm. The adaptive player matching application may be executed by the system in a manner known in the art. The adaptive player matching application may include one or more machine learning models (e.g., algorithms) configured to analyzing the implicit user gameplay information, including any inputs gathered by the system, to determine predicted user preferences for the first user.

Block 410 includes analyzing the implicit user gameplay information, via the adaptive player matching application, to determine predicted user preferences for the first user. Block 412 further includes predicting, by the adaptive player matching application, the user preferences for the first user. Predicted user preferences may include a preferred amount of communication, preferences for speed of completion of a game (e.g., users who like to speed through games may be a closer match than users who like to collect everything within the game), overlapping hours of play, preferred stop points or times within games, etc. For example, the adaptive player matching application may determine that users like to stop at similar points within the game (e.g., at checkpoints, after battles, at the beginning or end of levels, etc.). The recommended player matches may be designed to match user with similar interests, or the recommended player matches may match users with opposite preferences to keep the users playing longer. Other pairings may be used to form teams including two or more users for various games. In other embodiments, the adaptive player matching application may make quick connections between users who are interested in low stakes games (e.g., party games).

In some embodiments, process 400 may further include requesting user feedback at at least a predetermined time intervals in the game and, in response to the user feedback, modifying the predicted user preferences. For example, the process 400 may request feedback when user gameplay diverges from typical gameplay behavior. The process 400 may generate inquiries to determine whether the predicted user preferences are still accurate or whether the predicted user preferences need to be updated. In various embodiments, user gameplay information that diverges from predicted user preferences may trigger the process to generate clarifying questions for improving the accuracy of the predicted user preferences.

Block 414 includes, based at least in part on the predicted user preferences and the explicit user gameplay information, generating, via the adaptive player matching application, recommended player matches with one or more other users in the game environment. The adaptive player matching application receives the inputs and analyzes at least the implicit user gameplay information to determine predicted user preferences and recommended player matches for the first user.

Process 400 may include determining a user skill of the first user based on the analyzed implicit user gameplay information. The adaptive player matching application may then determine a complimentary skill to the user skill of the first user and, as part of the generating recommended player matches, the adaptive player matching application may select a recommended player match in the game environment with the complimentary skill. For example, users may have various user skills that may be used by the adaptive player matching application to generate recommended player matches. Exemplary skill pairings are described herein, especially with respect to FIG. 3. In some embodiments, the user skill includes a first tool available to the first user in the game environment (e.g., a specific weapon or power) and the complimentary skill includes a second tool available to the one or more other users in the game environment (e.g., a different weapon or power).

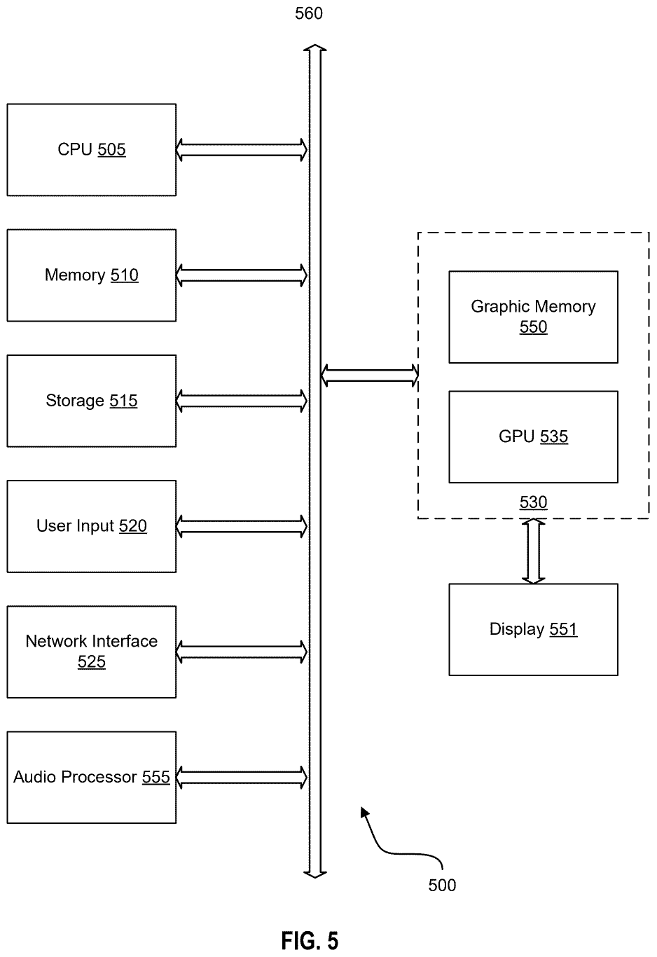

FIG. 5 illustrates an example of a hardware system suitable for implementing a computer system, according to embodiments of the present disclosure. The computer system 500 represents, for example, a video game system, a backend set of servers, or other types of a computer system. The computer system 500 includes a central processing unit (CPU) 505 for running software applications and optionally an operating system. The CPU 505 may be made up of one or more homogeneous or heterogeneous processing cores. Memory 510 stores applications and data for use by the CPU 505. Storage 515 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 520 communicate user inputs from one or more users to the computer system 500, examples of which may include keyboards, mice, thumbsticks, touch pads, touch screens, still or video cameras, and/or microphones. Network interface 525 allows the computer system 500 to communicate with other computer systems via an electronic communications network and may include wired or wireless communication over local area networks and wide area networks such as the Internet. An audio processor 555 is adapted to generate analog or digital audio output from instructions and/or data provided by the CPU 505, memory 510, and/or storage 515. The components of computer system 500, including the CPU 505, memory 510, data storage 515, user input devices 520, network interface 525, and audio processor 555 are connected via one or more data buses 560.

A graphics subsystem 530 is further connected with the data bus 560 and the components of the computer system 500. The graphics subsystem 530 includes a graphics processing unit (GPU) 535 and graphics memory 550. The graphics memory 550 includes a display memory (e.g., a frame buffer) used for storing pixel data for each pixel of an output image. The graphics memory 550 can be integrated in the same device as the GPU 535, connected as a separate device with the GPU 535, and/or implemented within the memory 510. Pixel data can be provided to the graphics memory 550 directly from the CPU 505. Alternatively, the CPU 505 provides the GPU 535 with data and/or instructions defining the desired output images, from which the GPU 535 generates the pixel data of one or more output images. The data and/or instructions defining the desired output images can be stored in the memory 510 and/or graphics memory 550. In an embodiment, the GPU 535 includes 3D rendering capabilities for generating pixel data for output images from instructions and data defining the geometry, lighting, shading, texturing, motion, and/or camera parameters for a scene. The GPU 535 can further include one or more programmable execution units capable of executing shader programs.

The graphics subsystem 530 periodically outputs pixel data for an image from the graphics memory 550 to be displayed on the display device 551. The display device 551 can be any device capable of displaying visual information in response to a signal from the computer system 500, including CRT, LCD, plasma, and OLED displays. The computer system 500 can provide the display device 551 with an analog or digital signal.

In accordance with various embodiments, the CPU 505 is one or more general-purpose microprocessors having one or more processing cores. Further embodiments can be implemented using one or more CPUs 505 with microprocessor architectures specifically adapted for highly parallel and computationally intensive applications, such as media and interactive entertainment applications.

Embodiments of the present disclosure provide systems and methods for adaptive player matching application that enhances user game play. Embodiments of the present disclosure leverage data from user profiles in a game environment and machine learning capabilities to match players across the globe. Embodiments of the present disclosure gather implicit and explicit information about user preferences to make player matches and adapt player matches as user preferences change. A further advantage of the adaptive player matching application as disclosed herein is the ability to determine user skills and complimentary skills and further take actions based on the complimentary skills. Accordingly, the adaptive player matching application is able to match a user with a player that supplements and enhances the user experience within the game environment and particularly within the game executed within the game environment. Accordingly, the adaptive player matching application supplements and enhances the user experience within the game environment and particularly within the game executed within the game environment. By optimizing data processing and reducing delays, the system ensures a seamless and dynamic user experience while maintaining high performance and scalability.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 46%, 135%, 90%, 100%, 105%, 109%, 109.9% or, depending on the context within which the term substantially appears, value otherwise as known in the art.

Additionally, spatially relative terms, such as “bottom” or “top” and the like can be used to describe an element and/or feature's relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method for executing an adaptive player matching application for interacting in a game environment, the method comprising:
tracking, by a system including at least one processor and a memory, user interactions of a first user in the game environment;
gathering, by the system, implicit user gameplay information from the user interactions of the first user in the game environment;
receiving, by the system, explicit user gameplay information from the first user;
executing, by the system, the adaptive player matching application including a machine learning algorithm;
analyzing the implicit user gameplay information, via the adaptive player matching application, to determine predicted user preferences for the first user;
determining, by the adaptive player matching application, the predicted user preferences for the first user; and
based at least in part on the predicted user preferences and the explicit user gameplay information, generating, via the adaptive player matching application, recommended player matches with one or more other users in the game environment.

2. The method of claim 1, further comprising training the machine learning algorithm on user interactions of at least a second user in the game environment.

3. The method of claim 1, wherein receiving the explicit user gameplay information comprises requesting the first user to provide game preferences prior to engaging with a game or during profile creation.

4. The method of claim 1, wherein the implicit user gameplay information is gathered from one or more inputs, wherein the one or more inputs comprises time data information associated with one or more titles in the game environment, player skill levels, shopping cart information, social media information, and user search history information.

5. The method of claim 1, further comprising:
determining, by the system using the machine learning algorithm, a user skill of the first user based on the implicit user gameplay information;
determining, by the system using the machine learning algorithm, a complimentary skill to the user skill of the first user; and
as part of the generating recommended player matches, selecting at least one of the one or more other users in the game environment with the complimentary skill.

6. The method of claim 5, wherein the user skill comprises a first tool available to the first user in the game environment and the complimentary skill comprises a second tool available to the one or more other users in the game environment.

7. The method of claim 1, further comprising:
requesting user feedback at at least a predetermined time intervals in a game; and
in response to the user feedback, modifying the predicted user preferences.

8. A system comprising:
one or more storage media storing instructions; and
one or more processors configured to execute the instructions causing the system to perform operations comprising:
tracking, by the system, user interactions of a first user in a game environment;
gathering, by the system, implicit user gameplay information from the user interactions of the first user in the game environment;
receiving, by the system, explicit user gameplay information from the first user;
executing, by the system, an adaptive player matching application including a machine learning algorithm;
analyzing the implicit user gameplay information, via the adaptive player matching application, to determine predicted user preferences for the first user;
determining, by the adaptive player matching application, the predicted user preferences for the first user; and
based at least in part on the predicted user preferences and the explicit user gameplay information, generating, via the adaptive player matching application, recommended player matches with one or more other users in the game environment.

9. The system of claim 8, further comprising training the machine learning algorithm on user interactions of at least a second user in the game environment.

10. The system of claim 8, wherein receiving the explicit user gameplay information comprises requesting the first user to provide game preferences prior to engaging with a game or during profile creation.

11. The system of claim 8, wherein the implicit user gameplay information is gathered from one or more inputs, wherein the one or more inputs comprises time data information associated with one or more titles in the game environment, player skill levels, shopping cart information, social media information, and user search history information.

12. The system of claim 8, further comprising:
determining, by the system using the machine learning algorithm, a user skill of the first user based on the implicit user gameplay information;
determining, by the system using the machine learning algorithm, a complimentary skill to the user skill of the first user; and
as part of the generating recommended player matches, selecting at least one of the one or more other users in the game environment with the complimentary skill.

13. The system of claim 12, wherein the user skill comprises a first tool available to the first user in the game environment and the complimentary skill comprises a second tool available to the one or more other users in the game environment.

14. The system of claim 8, further comprising:
requesting user feedback at at least a predetermined time intervals in a game; and
in response to the user feedback, modifying the predicted user preferences.

15. One or more non-transitory computer-readable storage media storing instructions that, upon execution by one or more processors of a system, cause the system to:
track, by the system, user interactions of a first user in a game environment;
gather, by the system, implicit user gameplay information from the user interactions of the first user in the game environment;
receive, by the system, explicit user gameplay information from the first user;
execute, by the system, an adaptive player matching application including a machine learning algorithm;
analyze the implicit user gameplay information, via the adaptive player matching application, to determine predicted user preferences for the first user;
determine, by the adaptive player matching application, predicted user preferences for the first user; and
based at least in part on the predicted user preferences and the explicit user gameplay information, generate, via the adaptive player matching application, recommended player matches with one or more other users in the game environment.

16. The computer-readable storage media of claim 15, further comprising training the machine learning algorithm on user interactions of at least a second user in the game environment.

17. The computer-readable storage media of claim 15, wherein receiving the explicit user gameplay information comprises requesting the first user to provide game preferences prior to engaging with a game or during profile creation.

18. The computer-readable storage media of claim 15, wherein the implicit user gameplay information is gathered from one or more inputs, wherein the one or more inputs comprises time data information associated with one or more titles in the game environment, player skill levels, shopping cart information, social media information, and user search history information.

19. The computer-readable storage media of claim 15, further comprising:
determining, by the system using the machine learning algorithm, a user skill of the first user based on the implicit user gameplay information;
determining, by the system using the machine learning algorithm, a complimentary skill to the user skill of the first user; and
as part of the generating recommended player matches, selecting at least one of the one or more other users in the game environment with the complimentary skill.

20. The computer-readable storage media of claim 19, wherein the user skill comprises a first tool available to the first user in the game environment and the complimentary skill comprises a second tool available to the one or more other users in the game environment.
